(19) United States
(12) Patent Application Publication
(10) Pub. No.: US 2024/0406129 A1
(43) Pub. Date: Dec. 5, 2024

(54) COGNITIVE ANALYSIS TO MANAGE ELECTRONIC MESSAGES ACROSS GROUP OF USERS

(71) Applicant: International Business Machines Corporation, Armonk, NY (US)

(72) Inventors: Wesley Ip, Arlington, TX (US); Logan Bailey, Atlanta, GA (US); Zachary A. Silverstein, Georgetown, TX (US); Alexandra M. Isaly, Lighthouse Point, FL (US)

(21) Appl. No.: 18/204,483

(22) Filed: Jun. 1, 2023

(51) Int. Cl. H04L 51/214; G06F 40/279; G06F 40/40; H04L 51/226

(52) U.S. Cl. CPC H04L 51/214; G06F 40/279; G06F 40/40; H04L 51/226

(57) ABSTRACT

Using cognitive analysis to manage electronic messages across a group of users. Analysis includes analyzing a received electronic inquiry and determining a list of potential recipients based on the electronic inquiry. Analysis further includes generating and sending a first electronic message incorporating the electronic inquiry for soliciting a response to the first recipient from the list. Further receiving and analyzing a first electronic response message from the device of the first recipient to determine if the first electronic response message meets an answering criteria for answering the electronic inquiry. In embodiments where it is determined the first electronic response message does not meet an answering criteria, generating and sending a second electronic message incorporating the electronic inquiry for soliciting a response to the second recipient from the list.

### BACKGROUND

The present invention relates generally to the field of electronic messaging from one recipient to another, and more particularly, computer management of electronic messaging and digital inquiries from one recipient to another.

Virtual message or chat messages are sent over the internet, Wi-Fi, or any other connected network. Virtual message works across channels and across devices. A virtual message can include a text message, email, chat message, or any means of textual communication between two devices. A chat box is the user interface of a given chat application. An instant message is a type of online chat allowing real-time text transmission over the Internet or another computer network. Messages are typically transmitted between two or more parties, when each user inputs text and triggers a transmission to the recipient, who are all connected on a common network.

An SME is an entity which may send or receive short virtual messages. SME is a term used in many cellular circles to describe a network entity such as a mobile device or user device that can send or receive messages. The SME may be located in a fixed network, a mobile, or short message service center (SMSC). An SME can be an external application which connects to a SMSC to engage in the sending or receiving of short message service (SMS) messages. SME's can be limited to a defined user group. Many companies, businesses, schools, universities, organizations, or any group establish a defined group of users for SME's for internal messages.

### SUMMARY

According to an embodiment of the present invention, management of electronic messaging and digital inquires can include cascading multiple digital communications and inquires, in one example, using a short message entity (SME).

According to one embodiment of the present invention, a computer-implemented method for managing an electronic inquiry across a defined group of users is disclosed. The computer-implemented method includes receiving, at a computer, an electronic inquiry from a user device. The computer-implemented method further includes analyzing, by the computer, the inquiry, the analyzing including NLP of the electronic inquiry. The computer-implemented method further includes generating, by the computer, a group of recipients based on the analysis of the electronic inquiry and profiles for the group of recipients. The computer-implemented method further includes generating, by the computer, a first electronic message incorporating, at least in part, the electronic inquiry for soliciting a response. The computer-implemented method further includes sending, by the computer, the first electronic message to a device of a first recipient from the group. The computer-implemented method further includes receiving, at the computer, a first electronic response message from the device of the first recipient. The computer-implemented method further includes analyzing, by the computer, the first electronic response message, the analyzing including NLP of the first electronic response message. The computer-implemented method further includes determining, by the computer, if the first electronic response message meets an answering criteria for answering the electronic inquiry.

According to another embodiment of the present invention, a computer program product for managing an electronic inquiry across a defined group of users is disclosed. The computer program product includes one or more computer readable storage media and program instructions stored on the one or more computer readable storage media. The program instructions include instructions to receive an electronic inquiry from a user device. The program instructions further include instructions to analyze the inquiry, the analyzing including NLP of the electronic inquiry. The program instructions further include instructions to generate a group of recipients based on the analysis of the electronic inquiry and profiles for the group of recipients. The program instructions further include instructions to generate a first electronic message incorporating, at least in part, the electronic inquiry for soliciting a response. The program instructions further include instructions to send the first electronic message to a device of a first recipient from the group. The program instructions further include instructions to receive a first electronic response message from the device of the first recipient. The program instructions further include instructions to analyze the first electronic response message, the analyzing including NLP of the first electronic response message. The program instructions further include instructions to determine if the first electronic response message meets an answering criteria for answering the electronic inquiry.

According to another embodiment of the present invention, a computer system for managing an electronic inquiry across a defined group of users is disclosed. The computer system includes one or more computer processors, one or more computer readable storage media, and computer program instructions, the computer program instructions being stored on the one or more computer readable storage media for execution by the one or more computer processors. The program instructions include instructions to receive an electronic inquiry from a user device. The program instructions further include instructions to analyze the inquiry, the analyzing including NLP of the electronic inquiry. The program instructions further include instructions to generate a group of recipients based on the analysis of the electronic inquiry and profiles for the group of recipients. The program instructions further include instructions to generate a first electronic message incorporating, at least in part, the electronic inquiry for soliciting a response. The program instructions further include instructions to send the first electronic message to a device of a first recipient from the group. The program instructions further include instructions to receive a first electronic response message from the device of the first recipient. The program instructions further include instructions to analyze the first electronic response message, the analyzing including NLP of the first electronic response message. The program instructions further include instructions to determine if the first electronic response message meets an answering criteria for answering the electronic inquiry.

### BRIEF DESCRIPTION OF DRAWINGS

The drawings included in the present disclosure are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 is a functional block diagram of computing environment, suitable for the execution of at least some of the computer code involved in performing the inventive methods, in accordance with at least one embodiment of the present invention.

FIG. 2 is a flow chart diagram depicting operations for a cascading message system, in accordance with at least one embodiment of the present invention.

FIG. 3 is another flow chart diagram depicting operations for a cascading message system, in accordance with at least one embodiment of the present invention.

FIG. 4 is a schematic diagram of a cascading messaging environment, in accordance with at least one embodiment of the present invention.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Embodiments of the present invention recognize the need to duplicate and iteratively transmit message content across a defined recipient group. Embodiments of the present invention recognize the need to receive an answer to a question with a minimal SME footprint. Embodiments of the present invention attempt to minimize the number of people contacted or messages sent in order to receive a positive answer to a proposed question. Embodiments of the present invention recognize a user may not always know the proper recipient to answer the user's question. Embodiments of the present invention recognize the need for the program to identify one or more recipients appropriate to answer the proposed question. In an embodiment the present invention identifies one or more appropriate recipients to answer the proposed question based on a recipient's job title, experience, or past questions they've answered. Embodiments of the present invention can further identify one or more appropriate recipients based on the context of the message or question to generate defined group of recipients based on the recipients' defined metadata and natural language understanding of message topic and context. Embodiments of the present invention further perform filtering or preexisting mapping for generating sequential ordering of the recipient array.

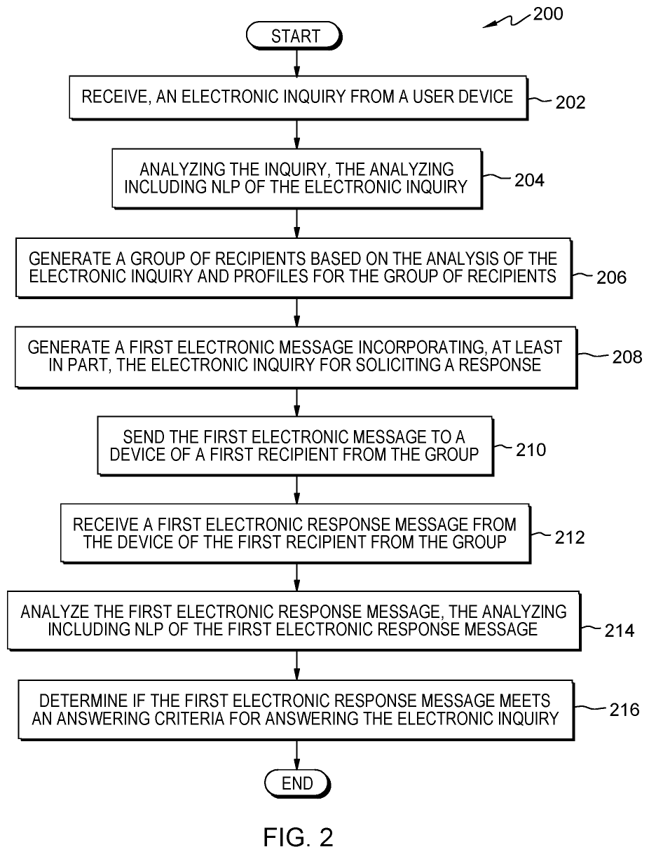

Embodiments of the present invention appreciate the substance of some message content contain time sensitive content and require an answer in a certain amount of time. Embodiments of the present invention trigger duplication and iterative message to subsequent recipients in a defined group when a time delay of a response is detected above a predetermined threshold. For example, if a message content includes “where is the 10 o'clock meeting today?” the message content includes time sensitive content and requires an answer to the question of where the meeting is before 10 o'clock today. Embodiments of the present invention recognize the need to trigger the generation and transmission of message content in response to detecting an unsatisfactory or no answer based on a time threshold. As depicted in FIG. 2, receiving an unsatisfactory answer or no answer to a first message to a first user triggers cascading message system to transmit a second message to a second recipient. Some embodiments of the present invention categorize received responses based on the context of the answer. If the response is in an unsatisfactory category, embodiments of the present invention trigger the transmission of a second message to a second recipient.

Embodiments of the present invention further recognize the need to minimize a footprint in SME by deleting unanswered messages. Additional embodiments of the present invention determine the context of a received response and stops duplication and iteration of a message across the recipient group. Further embodiments trigger deletion of sent messages upon detection of a successful response. Such as, if a first recipient received a first message with a question and does not answer, and embodiments of the present invention transmit a second message with the question to a second recipient and receive a positive answer to the question, embodiments of the present invention delete the first message with a question to the first recipient.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

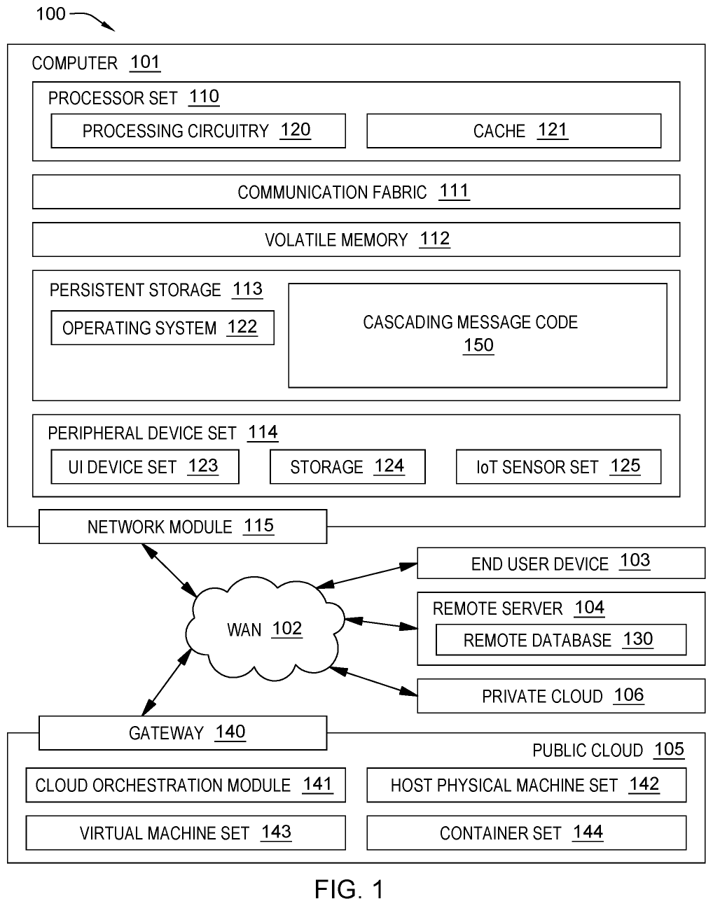

The present invention will now be described in detail with reference to the Figures. FIG. 1 is a functional block diagram of computing environment, generally designated 100, suitable for the execution of at least some of the computer code involved in performing the inventive methods, such as cascading message code 150, in accordance with at least one embodiment of the present invention. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication Fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile Memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In an embodiment, cascading message system may be configured to access various data sources, such as databases that may include personal data, content, contextual data, messages, user or recipient profiles, or information that a user does not want to be processed. Profiles of the groups of recipients can include each respective recipient's occupation, job title, job duties, status, schedule, workload, or any other personal identifying information. Personal data includes personally identifying information, sensitive personal information, user information, and messages received or sent from the user. In particular, identifying or personal information can include a user's job title, company, school, organization affiliation, responsibilities, or job description. Processing refers to any operation, automated or unautomated, or set of operations such as collecting, recording, organizing, structuring, storing, adapting, altering, retrieving, consulting, using, disclosing by transmission, dissemination, or otherwise making available, combining, restricting, erasing, or destroying personal data. In an embodiment, cascading message system enables the authorized and secure processing of personal data. In an embodiment, cascading message system provides informed consent, with notice of the collection of personal data, allowing the user to opt in or opt out of processing personal data. Consent can take several forms. Opt-in consent can impose on the user to take an affirmative action before personal data is processed. Alternatively, opt-out consent can impose on the user to take an affirmative action to prevent the processing of personal data before personal data is processed. In an embodiment, confidential communication system provides information regarding personal data and the nature (e.g., type, scope, purpose, duration, etc.) of the processing. In an embodiment, cascading message system provides a user with copies of stored personal data. In an embodiment, cascading message system allows for the correction or completion of incorrect or incomplete personal data. In an embodiment, cascading message system allows for the immediate deletion of personal data. In an embodiment, cascading message system provides informed consent, with notice of collecting, transmitting, and deleting messages and requires opt-in consent before collecting, transmitting, editing, and deleting messages. Alternatively, opt-out consent can impose on the user to take an affirmative action to prevent collecting, transmitting, editing, and deleting messages. Cascading message system receives informed opt-in consent from a user to collect, transmit, edit, delete messages, and access personal information. In an embodiment, cascading message system is represented by cascading message code 150.

In an embodiment, cascading message system retrieves SME expertise based on a dual factor model. One, expertise based on keyword analysis with co-side similarity. For example, RPA as keyword to determine RPA leaders. Another is expertise based on known corpus of SME assignment, such as manually inputted or received information. Within an ITSM, an RPA expert is assigned many RPA tasks.

In an embodiment, cascading message system trains an artificial intelligence or a machine learning module to generate a corpus. The corpus is trained with an artificial intelligence or a machine learning module to determine the proper or appropriate recipients for a question. Such as, the machine learning module is trained to generate a corpus of recipients for a type or context of a question. For example, the machine learning module is trained to determine the context of a question and the proper recipient who is likely to be able to answer the question. Such as, the machine learning module is trained to determine the context of the question is human resources and further is trained to determine a recipient in the human resources department. In some embodiments, cascading message system trains an artificial intelligence or a machine learning module to determine appropriate recipients from a predefined list of recipients. For example, cascading message system receives or determines an SME list and further trains an artificial intelligence or a machine learning module to determine appropriate recipients from the received SME list.

In an embodiment, cascading message system integrates with a SME or SME list. An SME list can be a corpus of personally known or an interacted corpus. In an embodiment, the SME list is provided for the user to select or unselect specific names. Further, in some embodiments, the SME list is dependent based on working hours, the time of day, availability, or activity metrics.

An SME list can include a list of one or more users or recipients. In an embodiment, the SME list further includes information of the users or recipients' organization, job title, company, school, affiliation, responsibilities, coworkers, chain of command, or job description. In an embodiment, cascading message system utilizes in group aggregation preexisting relationship mapping for generating sequential ordering of the recipient array. Relationship mapping is a visual representation of an organizational chart that gives an idea of the connections and influence each entity has over another. Relationship mapping can include a chain of command within a company. It should be appreciated any known in the art relationship mapping software can be utilized to generate a relationship map or organizational chart. The list can further be generated or determined by a defined group. For example, a defined group of all students in the school and cascading message system further generates a recipient list from the defined group.

Cascading message system retrieves or receives an electronic communication or electronic inquiry from a user device. In an embodiment, the electronic communication includes a message, email, text message, or any type of electronic message. The electronic communication further can include an inquiry, query, or question. Cascading message system can retrieve an electronic inquiry by receiving the message from a user, SME, an open search, a communication channel post, email, internal or external messaging system, or any other type of electronic social interaction. For example, cascading message system monitors a communication channel to determine if any message contain a question or inquiry requiring an answer. In an embodiment, the user device can include any device, tablet, computer, phone, or similar capable of sending and receiving electronic messages.

Cascading message system analyzes the electronic inquiry. The analyzing including natural language processing (NLP) of the inquiry and knowledge resources. Knowledge resources can include a database of predetermined answer and question pairs or a database of answers. In an embodiment, cascading message system receives a query indicative post and based on sentence sentiment and linguistic NLP determines an interrogative command about technical subject matter area or a topic. For example, cascading message system analyzes an electronic inquiry of “what time is chemistry 101 class” with linguistic NLP to determine the topic of the electronic inquiry is “class schedules.” In an embodiment, cascading message system determines an indicative post, message, question, inquiry, or query based on sentence sentiment and linguistic NLP. In an embodiment, cascading message system utilizes sentence sentiment or NLP to determine a technical subject matter, context, or topic of the message. The technical subject matter may be predefined based on the trained corpus. In an embodiment, cascading message system processes the message to determine the technical subject matter, topic, or keywords using cosine similarity. Cosine similarity measures the similarity between two vectors of an inner product space and is often used to measure similarity in text analysis based on terms of their subject matter. It should be appreciated that any known in the art text similarity analysis or similar can be used to determine or match the subject matter or topic of text of the received message to a known subject matter or corpus. In some embodiments, cascading message system accesses a database or any knowledge resources in order to determine a technical subject matter, context, or topic of the message.

In an example, cascading message system monitors a help center communication channel and determines a user sent a question to the communication channel stating, “does anyone know how to request a new office badge?” Here, cascading message system further determines with sentence sentiment and linguistic NLP the topic of the message to be an inquiry for the security or IT department. Cascading message system further determines an ordered group of recipients from the security and IT department whose job description includes “office badge.”

In an embodiment, generates a group of one or more appropriate recipients to receive a message based on the analysis of the electronic inquiry. In an embodiment, cascading message system receives a group of recipients from the user as user input. In some embodiments, the group or list received is an ordered sequential list. For example, the group indicates an ordered list of recipients to send cascading messages to starting from the first recipient. The list or group of one or more recipients can be from a defined group which can include any predetermined group or list of potential recipients. A defined group can include a list of employees in a business or students in a school. For example, cascading message system receives a list of all the employees of a business and from the list of all employees generates a group of recipients based on the analysis of the electronic inquiry. A defined group can also include any recipients on a communication channel or application. For example, a particular IT channel within a company and all the recipients or users apart of this IT channel. In some embodiments, cascading message system receives or generates the defined groups. In some examples, the group is categorized into categorizes such as by profile, department, specialty, job title, or any other sorting arrangement. In an embodiment the group is an SME list. In some embodiments, the SME list is based, at least in part, on the user's personally known or interacted corpus. Such as, the SME list includes recipients the user has messaged previously or previous answers to previous questions. In some embodiments, the SME list is provided to the user to select or unselect specific names or potential recipients. In an embodiment, cascading message system adds or removes potential recipients from the SME list based on a potential recipients respective working hours, availability, workload, or activity metrics. For example, an SME list includes: (i) first employee; (ii) second employee; and (iii) third employee, but third employee is not working today, cascading message system removes the third employee from the SME list.

In an embodiment, cascading message system determines a priority level for a message or query. The priority level is dependent on many factors including the context, sentiment, or language of the message. Such as the words determined in the message by NLP indicate a high or low priority. For example, any message that includes certain words or punctuation are automatically determined as high priority. Such as a message including the word “urgent,” capital letters, or exclamation points. Additionally, the priority level can be manually set by the user. Such as, cascading message system receives user input that a message is high or low priority.

In an embodiment, cascading message system determines the time an answer to the message or query is required by or how much time between when the message was received and when an answer is required by. For example, if at 1 pm cascading message system receives a message stating “please let me know by 3 pm today if you can make it to the game tonight” cascading message system determines there is 2 hours between when the message was received and the time the answer to message or query is required by. The priority level can be dependent on the amount of time between the received message or query and the time the answer to the message or query is required by. Such as a message requiring an answer in a week has a lower priority level than a message requiring an answer in 3 hours. In another example, a first message received at 10 am stating “where is the meeting at noon today?” will have a higher priority level than a second message received at 10 am stating “where is the meeting tomorrow at noon?” since there is less amount of time between then the first message is received and when the answer is required by than the second message.

The priority level of the message can impact the cascading metrics, such as the amount of time between transmitting messages to individuals, the amount of iterations or messages to be transmitted, the type of NLP interacts a cancellation response for the individual. For example, if cascading message system receives an email with a high priority level, cascading message system decreases the amount of time between transmitting cascading messages to the next recipient. In an embodiment, cascading message system assigns a priority level score to a message based on the context. In some embodiments, cascading message system distributes to the list of SME's based on the priority level. For example, a message with a higher priority level will have a lower amount of time between transmitting messages to individuals verses a message with a lower priority score. Such as, waiting 10 minutes between sending each message for a high priority score verses waiting 30 minutes between sending each message for a low priority score. an embodiment, if a priority level is above a predetermined threshold, cascading message system is triggered to transmit a predetermined number of message or transmit message in under a predetermined amount of time. For example, if a priority level threshold is a score of 6, if cascading message system determines a message's priority level is a 7, cascading message system transmits the number of message or amount of time between messages based on the message's priority level of a 7. In some embodiments, a priority score may require double validation. Meaning, if an inquiry is important enough, cascading message system will stop cascading messages to recipients once it receives two of the same, or similar, messages from two different recipients. This increases the likelihood that the two messages received from two different recipients contain the correct answer to the inquiry.

In some embodiments, user input is received including what time and/or day to transmit one or more messages, a deadline, or the time and/or day the user would like an answer by. For example, cascading message system receives user input to transmit a first message to a first user at 1 μm and if cascading message system does not receive a response from the first user by 4 μm to transmit a second message to a second user.

In an embodiment, cascading message system generates an electronic message based on the received electronic communication or inquiry from the user. For example, if cascading message system receives a inquiry from a user stating, “where do we return the documents from the group meeting?” cascading message generates a first message to the first recipient, Jane, stating “Hi Jane, where do we return the documents form the group meeting?”

In an embodiment, cascading message system sends by the computer the first electronic message to a device of a first recipient from the group. A device of a first recipient from the group can include an electronic device capable of sending and receiving messages registered to a user. Such as a phone, tablet, or computer. A device of a first recipient from the group can also include an electronic account of the user or database. For example, cascading message system sends by the computer the first electronic message as an email to the email account of the first recipient from the group. Further, the user can access the email of the first electronic message from their email account from any electronic device capable of sending and receiving electronic messages.

In an embodiment, cascading message system triggers transmission of or sends by a computer one or more messages upon receiving approval from the user. Such as, cascading message system displays one or more message options or recipients for approval to the user and receives user input of approval to transmit one or more messages to one or more recipients. In an embodiment, cascading message system provides and displays to the user the option to execute a cascading message. In an example, cascading message system utilizes an agent embedded in a collaborate means with edible constraints such as email, instant messenger, a chat box, or other chat channel to transmit a message.

In an embodiment, cascading message system receives at the computer a first electronic response message from the device of the first recipient from the group. In an embodiment, cascading message system analyzes the first electronic response message by utilizing NLP on the first electronic response message. In an embodiment, cascading message system determines if a response answers the question from the original message based on the context of the response. Cascading message system utilizes NLP and sentence sentiment to determine the words and context of the response. In some embodiments, cascading message system utilizes artificial intelligence (AI) or machine learning (ML) to determine if a response answers or does not answer the question in the original query. In these embodiments, cascading message system trains or utilizes a trained artificial intelligence or machine learning to determine if a response answers or does not answer the question. In some embodiments, cascading message system utilizes artificial intelligence or machine learning to determine if a response correctly answers a question based on sentence sentiment and linguistic natural language processing (NLP).

In some embodiments, cascading message system utilizes artificial intelligence or machine learning to match the question or query to a previous question and answer pair. For example, if the received question is “what time is the monthly office meeting” cascading message system matches the words in the received question to a previously determined question and answer pair of “what time does the monthly office meeting start” and the answer “noon.” In some embodiments, cascading message system utilizes any generally known in the art recursive neural network system to determine if a response or answer correctly answers the question.

In an embodiment, cascading message system determines the answer in a reply message meets an answering criteria. In an embodiment, the answering criteria is a metric to determine if the electronic response message answers the original received electronic inquiry or the first electronic message. For example, the answering criteria can be a numerical number, fraction, or percentage of answering the question. For example, if a question says, “when and where is lunch today?” and the received answer or response is “lunch is at noon” cascading message system determines the response answers 50% of the question by only answering when lunch is and does not answer the location of the lunch. In this example, if the answering criteria to the inquiry is the response must answer 60% of the original question or higher, cascading message system further determines the response is does not meet the answering criteria. In another example, cascading message system determines a percentage of the probability that the received response answers the question. For example, cascading message system utilizes AI or ML to determine there is a 77% probability the received response answers the question based on performing NLP on the answer in the received response.

In an embodiment, the answering criteria is based on a numerical number assigned to the response. For example, cascading message system gives a numerical rating to each response based on the context of the response and if the response answers the proposed question in the message. In an embodiment, cascading message system receives user input a response answers the question. In these embodiments, cascading message system determines the answering criteria is met.

In some embodiments, cascading message system compares the answer to key words in a database using NLP of the answer. In some embodiments, cascading message system utilizes cosine similarity to determine if a response correctly answers a question. Cosine similarity is a metric used to measure how similar the documents are irrespective of their size. Mathematically, it calculates the cosine of the angle between two vectors projected in a multi-dimensional space.

In some embodiments, if cascading message system does not receive a response from a recipient in a predetermined amount of time, cascading message system determines the answering criteria is not met. In some embodiments where the answering criteria is not met, cascading message system triggers the transmission of a second message to a second recipient. Cascading message system reiterates the steps of generating new messages and transmitting messages to recipients on the list until a response meets the answering criteria.

FIG. 2 is a flow chart diagram depicting operational steps for cascading messaging system, generally designated 200, in accordance with at least one embodiment of the present invention. FIG. 2 provides only an illustration of one implementation and does not imply any limitations with regard to the environments in which different embodiments may be implemented. Many modifications to the depicted environment may be made by those skilled in the art without departing from the scope of the invention as recited by the claims.

The cascading message system receives, at a computer, an electronic inquiry from a user device, as shown in block 202. The electronic inquiry includes a question, query, message, requiring an answer or to solicit a response to the inquiry.

The cascading message system analyzing, by the computer, the inquiry, the analyzing including NLP of the electronic inquiry, as shown in block 204. In an embodiment, cascading message system accesses a knowledge resource to analyze the inquiry.

The cascading message system generates, by the computer, a group of recipients, based on the analysis of the electronic inquiry and profiles for the group of recipients, as shown in block 206. In some embodiments, the group of recipients is a defined group, SME list, or received list of recipients. Profiles of the groups of recipients can include each respective recipient's occupation, job title, job duties, status, schedule, workload, or any other identifying information. For example, the received communication is “where is the staff meeting this afternoon?” and cascading message system determines Anne whose job title in their profile is “Staff Director” as the first appropriate recipient from the list and generates the first message as “Hi Anne, where is the meeting this afternoon?”

The cascading message system, generates, by the computer a first electronic message incorporating, at least in part, the electronic inquiry, as shown in block 208.

The cascading message system sends, by the computer, the first electronic message to a device of a first recipient from the group, as shown in block 210.

The cascading message system receives, at the computer, a first electronic response message from the device of the first recipient from the group, as shown in block 212.

The cascading message system analyzes, by the computer, the first electronic response message, the analyzing including NLP of the first electronic response message, as shown in block 214.

The cascading message system determines, by the computer, if the first electronic response message meets an answering criteria for answering the electronic inquiry, as shown in block 216. An answering criteria can include a predetermined time threshold after sending the first electronic message to a device of a first recipient. The answering criteria can further include determining if the first electronic response message answered the inquiry or the first electronic message.

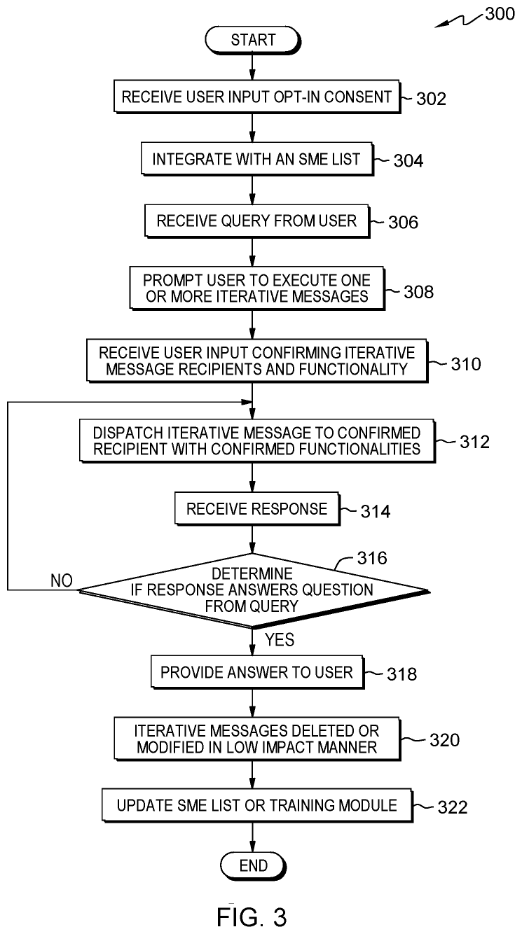

FIG. 3 is a diagram depicting an environment for cascading message system, generally designated 300, in accordance with at least one embodiment of the present invention. FIG. 3 provides only an illustration of one implementation and does not imply any limitations with regard to the environments in which different embodiments may be implemented. Many modifications to the depicted environment may be made by those skilled in the art without departing from the scope of the invention as recited by the claims.

FIG. 3 is a flow chart diagram depicting operational steps for cascading messaging system, generally designated 300, in accordance with at least one embodiment of the present invention. FIG. 3 provides only an illustration of one implementation and does not imply any limitations with regard to the environments in which different embodiments may be implemented. Many modifications to the depicted environment may be made by those skilled in the art without departing from the scope of the invention as recited by the claims.

The cascading message system receives user input opt-in consent, as shown in block 302.

The cascading message system integrates with an SME list, as shown in block 304.

The cascading message system receives a query from the user, as shown in block 306.

The cascading message system prompts a user to execute one or more iterative messages, as shown in block 308.

The cascading message system receives user input confirming iterative message recipients and functionalities, as shown in block 310. Such as, cascading message system displaying a digital pop-up box on the user interface of a user device requesting permission to execute one or more iterative messages to one or more recipients.

The cascading message system dispatches iterative messages to confirmed recipient with confirmed functionalities, as shown in block 312.

The cascading message system receives a response, as shown in block 314.

The cascading message system determines if response answers question from query, as shown in decision block 316. Responsive to determining the response from the query does not answer the users question, cascading message system dispatches iterative messages to confirmed recipient with confirmed functionalities, as shown in block 312.

Responsive to determining the response from the query answers the user's question, cascading message system provides the answer to the user, as shown in block 318.

The cascading message system deletes or modifies iterative messages in low impact manner, as shown in block 320.

The cascading message system updates SME list or training model, as shown in block 322.

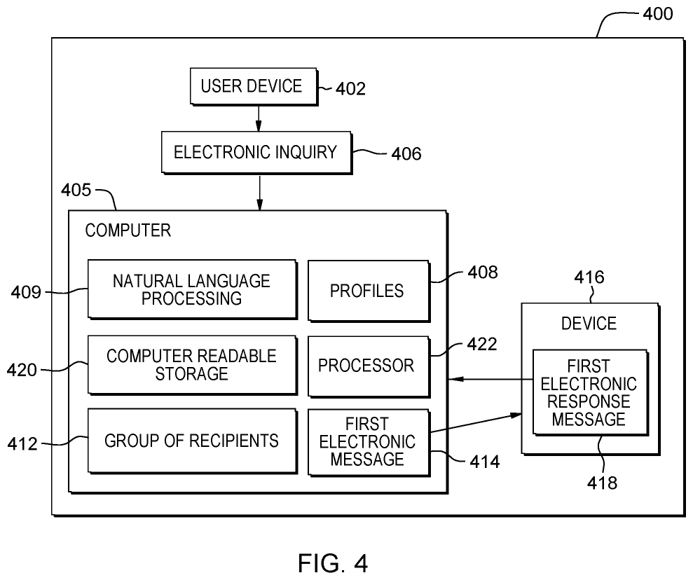

As depicted in FIG. 4, environment 400, includes user device 402, electronic inquiry 406, computer 405, and device 416 communicably connected. User device 402, inquiry 406, computer 405, and device 416 are communicably connected on a network or by means of Wi-Fi, the internet, cables, or any other type of known means for communicably connecting. In an embodiment device 416 include a respectable user device, account, or database for a first recipient.

As depicted, computer 405 includes profiles. 408, natural language processing 409, group of recipients 412, first electronic message 414, computer readable storage 420, and processor 422. Device 416 includes first electronic response message 418.

In an example, computer 405 receives electronic inquiry 406 from user device 402. Cascading message system generates first electronic message 414 based, at least in part, on electronic inquiry 406. Cascading message system transmits first electronic message 414 to device 416. Cascading message system further receives first electronic response message 418 from device 416. Cascading message system further analyzes first electronic response message 418. The analyzing including natural language processing 409 of first electronic response message 418. Cascading message system determines by the computer, if first electronic response message 418 meets an answering criteria for answering electronic inquiry 406.

1. A computer-implemented method for managing an electronic inquiry across a defined group of users, the computer-implemented method comprising:
receiving, at a computer, the electronic inquiry from a user device of a user;
analyzing, by the computer, the electronic inquiry, the analyzing including determining a subject matter of a question included in the electronic inquiry by a natural language processing (NLP) of the electronic inquiry and by using a cosine similarity that matches text in the question to known subject matter;
generating, by the computer, a group of recipients, wherein the group of recipients is based on (i) the subject matter of the question and (ii) other questions the recipients in the group of recipients have previously answered;
generating, by the computer, a first electronic message incorporating, at least in part, the electronic inquiry for soliciting a response to the question;
sending, by the computer, the first electronic message to a device of a first recipient from the group of recipients, the device of the first recipient being a short message entity;
determining, by the computer, that an amount of time after the sending the first electronic message exceeds a time threshold without a first electronic response message responding to the first electronic message been received from the device of the first recipient;
responsive to the determining that the amount of time exceeds the time threshold, generating, by the computer, a second electronic message incorporating, at least in part, the electronic inquiry for soliciting the response to the question;
sending, by the computer, the second electronic message to a device of a second recipient from the group of recipients, the second recipient being different from the first recipient;
receiving, at the computer, a second electronic response message from the device of the second recipient;
analyzing, by the computer, the second electronic response message, the analyzing of the second electronic response message including determining, by using artificial intelligence, that a response in the second electronic response message is a correct answer to the question by using sentence sentiment and NLP of the response in the second electronic response message and by matching the question to a previous question in a previous question and answer pair; and
responsive to the determining that the response in the second electronic response message is the correct answer, minimizing a footprint in the short message entity by deleting, by the computer, the first electronic message.

2. (canceled)

3. The computer-implemented method of claim 1, further comprising:
receiving, at the computer, a second electronic inquiry from a second user device of a second user;
analyzing, by the computer, the second electronic inquiry, the analyzing of the second electronic inquiry including determining a subject matter of a second question included in the second electronic inquiry by NLP of the second electronic inquiry;
generating, by the computer, a second group of recipients, wherein the second group of recipients is based on (i) the subject matter of the second question and (ii) other questions the recipients in the second group of recipients have previously answered;
generating, by the computer, a third electronic message incorporating, at least in part, the second electronic inquiry for soliciting a response to the second question;
sending, by the computer, the third electronic message to a device of a first recipient from the second group of recipients;
receiving, by the computer, a third electronic response message from the device of the first recipient from the second group of recipients;
determining, by the computer, that a response included in the third electronic response message answers a percentage of the second question;
determining, by the computer, that the response included in the third electronic response does not meet an answering criteria based on the percentage of the second question being less than a threshold percentage; and
responsive to the response included in the third electronic response not meeting the answering criteria, repeating generating, by the computer, electronic messages incorporating, at least in part, the second electronic inquiry and sending, by the computer, the electronic messages to devices of recipients from the group of recipients according to a sequential ordering of the group of recipients until a receipt of an electronic response message from one of the recipients which includes a response to the second question that meets the answering criteria.

4. The computer-implemented method of claim 1, further comprising:
receiving, at the computer, a second electronic inquiry from a second user device of a second user;
analyzing, by the computer, the second electronic inquiry, the analyzing of the second electronic inquiry including determining a subject matter of a second question included in the second electronic inquiry by NP of the second electronic inquiry;
generating, by the computer, a second group of recipients, wherein the second group of recipients is based on (i) the subject matter of the second question and (ii) other questions the recipients in the second group of recipients have previously answered;
generating, by the computer, a third electronic message incorporating, at least in part, the second electronic inquiry for soliciting a response to the second question;
sending, by the computer, the third electronic message to a device of a first recipient from the second group of recipients;
receiving, by the computer, a third electronic response message;
comparing, by the computer, a response included in the third electronic response message to key words in a database using NLP of the response included in the third electronic response message;
determining, by the computer, that the response included in the third electronic response message does not meet an answering criteria based on the comparing the response included in the third electronic response message to the key words; and
responsive to the response included in the third electronic response not meeting the answering criteria, repeating generating, by the computer, electronic messages incorporating, at least in part, the second electronic inquiry and sending, by the computer, the electronic messages to devices of recipients from the group of recipients according to a sequential ordering of the group of recipients until a receipt of an electronic response message from one of the recipients which includes a response that meets the answering criteria.

5. The computer-implemented method of claim 1, further comprising:
determining, by the computer and using NLP, that words in the first electronic message indicate a priority level of the electronic inquiry, the priority level being a first priority level (high priority) or a second priority level (low priority), the first priority level indicating a higher level of priority than the second priority level; and
determining by the computer, the time threshold based on the priority level of the electronic inquiry.

6. The computer-implemented method of claim 1, wherein the group of recipients is based, at least in part, on a subject matter expert list.

7. The computer-implemented method of claim 1, further comprising:
determining, by the computer, an amount of time between when the electronic inquiry was received and when an answer to the question is required;
determining a priority level of the electronic inquiry based on the amount of time between when the electronic inquiry was received and when the answer to the question is required; and
determining the time threshold based on the priority level of the electronic inquiry.

8. (canceled)

9. The computer-implemented method of claim 1, further comprising:
determining job titles of recipients included in the group of recipients by accessing a database that includes profiles of the recipients, wherein the group of recipients is based, at least in part, on the job titles of the recipients.

10. (canceled)

11. A computer program product for managing an electronic inquiry across a defined group of users, the computer program product comprising one or more computer readable storage media and program instructions stored on the one or more computer readable storage media, the program instructions including instructions to:
receive the electronic inquiry from a user device of a user;
analyze the electronic inquiry, the analyzing including determining a subject matter of a question included in the electronic inquiry by a natural language processing (NLP) of the electronic inquiry and by using a cosine similarity that matches text in the question to known subject matter;
generate a group of recipients, wherein the group of recipients is based on (i) the subject matter of the question and (ii) other questions the recipients in the group of recipients have previously answered;
generate a first electronic message incorporating, at least in part, the electronic inquiry for soliciting a response to the question;
send the first electronic message to a device of a first recipient from the group of recipients, the device of the first recipient being a short message entity;
determine that an amount of time after sending the first electronic message exceeds a time threshold without a first electronic response message responding to the first electronic message being received from the device of the first recipient;
responsive to determining that the amount of time exceeds the time threshold, generate a second electronic message incorporating, at least in part, the electronic inquiry for soliciting the response to the question;
send the second electronic message to a device of a second recipient from the group of recipients, the second recipient being different from the first recipient;
receive a second electronic response message from the device of the second recipient;
analyze the second electronic response message, the analyzing of the second electronic response message including determining, by using artificial intelligence, that a response in the second electronic response message is a correct answer to the question by using sentence sentiment and NLP of the response in the second electronic response message and by matching the question to a previous question in a previous question and answer pair; and
responsive to determining that the response in the second electronic response message is the correct answer, minimize a footprint in the short message entity by deleting the first electronic message.

12. (canceled)

13. The computer program product of claim 11, wherein the program instructions include further instructions to:
receive a second electronic inquiry from a second user device of a second user;
analyze the second electronic inquiry, the analyzing of the second electronic inquiry including determining a subject matter of a second question included in the second electronic inquiry by NLP of the second electronic inquiry;
generate a second group of recipients, wherein the second group of recipients is based on (i) the subject matter of the second question and (ii) other questions the recipients in the second group of recipients have previously answered;
generate a third electronic message incorporating, at least in part, the second electronic inquiry for soliciting a response to the second question;
send the third electronic message to a device of a first recipient from the second group of recipients;
receive a third electronic response message from the device of the first recipient from the second group of recipients;
determine that a response included in the third electronic response message answers a percentage of the second question;
determine that the response included in the third electronic response does not meet an answering criteria based on the percentage of the second question being less than a threshold percentage; and
responsive to the response included in the third electronic response not meeting the answering criteria, repeating generating electronic messages incorporating, at least in part, the second electronic inquiry and sending the electronic messages to devices of recipients from the second group of recipients according to a sequential ordering of the second group of recipients until a receipt of an electronic response message from one of the recipients which includes a response to the second question that meets the answering criteria.

14. The computer program product of claim 11, wherein the program instructions include further instructions to:
receive a second electronic inquiry from a second user device of a second user;
analyze the second electronic inquiry, the analyzing of the second electronic inquiry including determining a subject matter of a second question included in the second electronic inquiry by NLP of the second electronic inquiry;
generate a second group of recipients, wherein the second group of recipients is based on (i) the subject matter of the second question and (ii) other questions the recipients in the second group of recipients have previously answered;
generate a third electronic message incorporating, at least in part, the second electronic inquiry for soliciting a response to the second question;
send the third electronic message to a device of a first recipient from the second group of recipients;
receiving, by the computer, a third electronic response message from the device of the first recipient from the second group of recipients;
compare a response included in the third electronic response message to key words in a database using NLP of the response included in the third electronic response message;
determine that the response included in the third electronic response message does not meet an answering criteria based on comparing the response included in the third electronic response message to the key words, and
responsive to the response included in the third electronic response not meeting the answering criteria, repeating generating electronic messages incorporating, at least in part, the second electronic inquiry and sending the electronic messages to devices of recipients from the second group of recipients according to a sequential ordering of the second group of recipients until a receipt of an electronic response message from one of the recipients which includes a response that meets the answering criteria.

15. The computer program product of claim 11, wherein the program instructions include further instructions to:
determine using NLP that words in the first electronic message indicate a priority level of the electronic inquiry, the priority level being a first priority level (high priority) or a second priority level (low priority), the first priority level indicating a higher level of priority than the second priority level; and
determine the time threshold based on the priority level of the electronic inquiry.

16. The computer program product of claim 11, wherein the group of recipients is based, at least in part, on a subject matter exert entity-list.

17. The computer program product of claim 11, wherein the program instructions include further instructions to:
determine an amount of time between when the electronic inquiry was received and when an answer to the question is required;
determine a priority level of the electronic inquiry based on the amount of time between when the electronic inquiry was received and when the answer to the question is required; and
determine the time threshold based on the priority level of the electronic inquiry.

18. (canceled)

19. The computer program product of claim 11, wherein the program instructions include further instructions to:
determine job titles of recipients included in the group of recipients by accessing a database that includes profiles of the recipients, wherein the group of recipients is based, at least in part, on the job titles of the recipients.

20. A computer system for managing an electronic inquiry across a defined group of users, comprising:
one or more computer processors;
one or more computer readable storage media;
computer program instructions;
the computer program instructions being stored on the one or more computer readable storage media for execution by the one or more computer processors; and
the computer program instructions including instructions to:
receive the electronic inquiry from a user device of a user;
analyze the electronic inquiry, the analyzing including determining a subject matter of a question included in the electronic inquiry by a natural language processing (NLP) of the electronic inquiry and by using a cosine similarity that matches text in the question to known subject matter;
generate a group of recipients, wherein the group of recipients is based on (i) the subject matter of the question and (ii) other questions the recipients in the group of recipients have previously answered;
generate a first electronic message incorporating, at least in part, the electronic inquiry for soliciting a response to the question;
send the first electronic message to a device of a first recipient from the group of recipients, the device of the first recipient being a short message entity;
determine that an amount of time after sending the first electronic message exceeds a time threshold without a first electronic response message responding to the first electronic message being received from the device of the first recipient;
responsive to determining, that the amount of time exceeds the time threshold, generate a second electronic message incorporating, at least in part, the electronic inquiry for soliciting the response to the question;
send the second electronic message to a device of a second recipient from the group of recipients, the second recipient being different from the first recipient;
receive a second electronic response message from the device of the second recipient;
analyze the second electronic response message, the analyzing of the second electronic response message including determining, by using artificial intelligence, that a response in the second electronic response message is a correct answer to the question by using sentence sentiment and NLP of the response in the second electronic response message and by matching the question to a previous question in a previous question and answer pair; and
responsive to determining that the response in the second electronic response message is the correct answer, minimize a footprint in the short message entity by deleting the first electronic message.
